(19) United States
(12) Patent Application Publication
(10) Pub. No.: US 2017/0270045 A1
(43) Pub. Date: Sep. 21, 2017

(54) HYBRID MEMORY DEVICE AND OPERATING METHOD THEREOF

(71) Applicant: SK hynix Inc., Gyeonggi-do (KR)

(72) Inventors: Jung-Hyun KWON, Gyeonggi-do (KR); Jing-Zhe XU, Gyeonggi-do (KR); Du-Hyun KIM, Gyeonggi-do (KR)

(21) Appl. No.: 15/230,081

(22) Filed: Aug. 5, 2016

(30) Foreign Application Priority Data
Mar. 17, 2016 (KR) 10-2016-0032301

(51) Int. Cl. G06F 12/0811; G06F 12/0815; G06F 12/0804

(52) U.S. Cl. CPC G06F 12/0811; G06F 12/0804; G06F 12/0815; G06F 2212/1021; G06F 2212/1024; G06F 2212/283; G06F 2212/608

(57) ABSTRACT

A memory device may include: a data determination unit for receiving page data from a main memory device, and distinguishing between first and second data based on tag information of the page data; an index management unit for storing an index of the first data; a first cache for storing the second data, and writing back first victim data to the main memory device, the first victim data being selected when the first cache is full; and a second cache for storing the first victim data transferred from the first cache when a write count of the first victim data is smaller than a first threshold value, updating tag information of second victim data to a value indicating the first data, the second victim data being selected when the second cache is full, and storing the second victim data in the main memory device.

### CROSS-REFERENCE TO RELATED APPLICATIONS

This application claims priority under 35 U.S.C. §119 to Korean Patent Application No. 10-2016-0032301, filed on Mar. 17, 2016, in the Korean Intellectual Property Office, the disclosure of which is incorporated herein by reference in its entirety.

### BACKGROUND

1. Field

Various embodiments of this application relate generally to a semiconductor design technology and, more particularly, to a hybrid memory device capable of managing cold data and hot data.

2. Description of the Related Art

Semiconductor memory devices are generally categorized into volatile memory devices and nonvolatile memory devices.

A volatile memory device has high write and read speed, but loses data stored therein when the power supply to the device is cut off. Examples of volatile memory devices include a Dynamic Random Access Memory (DRAM), a Static RAM (SRAM) and the like. A nonvolatile memory device has relatively lower write and read speeds than a volatile memory device, but retains data stored therein even though the power supply to the device is cut off. Thus, a nonvolatile memory device is typically used to store data which need to be retained regardless of whether power is supplied. Examples of nonvolatile memory devices include a Read Only Memory (ROM), a Mask ROM (MROM), a Programmable ROM (PROM), an Erasable Programmable ROM (EPROM), an Electrically Erasable Programmable ROM (EEPROM), flash memory, a Phase Change Random Access Memory (PCRAM), a Magnetic RAM (MRAM), a Resistive RAM (RRAM), and a Ferroelectric RAM (FRAM).

A memory system may include various types of memories which can be used by a user. A RAM is a typical high-speed access memory which is used for frequent read and write operations in a computer system. Examples of a RAM may include a DRAM, a SRAM, a Spin-Torque Transfer Random Access Memory (STT-RAM) and a PCRAM. Nowadays, a RAM is necessary for all types of computation equipment from handheld devices to a large-scale data center.

The respective memories have their advantages and disadvantages in terms of delay/performance, capacity and energy consumption. For example, while a PCRAM is a nonvolatile memory device, a DRAM is a volatile memory device. Generally, a PCRAM has better scalability than a DRAM. On the other hand, a DRAM has much higher write speed and slightly higher read speed than a PCRAM. Furthermore, a PCRAM uses a larger amount of energy during a write operation, and has a limited write durability. Recently, there has been proposed a hybrid memory device which includes a volatile memory device and a nonvolatile memory device and exhibits the advantages of the volatile memory device and the advantages of the nonvolatile memory device.

### SUMMARY

Various embodiments of the present invention are directed to a method for managing hot data and cold data using a cache in a hybrid memory device.

In an embodiment, a memory device may include: a data determination unit suitable for receiving page data from a main memory device, and determining whether the page data includes one of first data and second data based on a tag information of the page data; an index management unit suitable for storing an index of the first data if it is determined that the page data includes the first data; a first cache suitable for storing the second data if it is determined that the page data includes the second data, and writing back first victim data to the main memory device, the first victim data being selected when the first cache is full; and a second cache suitable for storing the first victim data transferred from the first cache when a write count of the first victim data is less than a first threshold value, updating tag information of second victim data to a value indicating the first data, the second victim data being selected when the second cache is full, and storing the second victim data in the main memory device.

In an embodiment, a hybrid memory device may include: a first memory device suitable for storing page data including page information and tag information; a control logic suitable for receiving the page data from the first memory device, determining whether the page data includes one of cold data and normal data based on the tag information of the page data, and storing and managing an index of the cold data; and a second memory device accessed at a different operating speed from the first memory device, and suitable for storing the normal data and updating the tag information of the page data stored in the first memory device according to a write count of the stored normal data.

In an embodiment, there is provided an operating method of a hybrid memory device which includes a first memory device suitable for storing page data including page information and tag information and a second memory device accessed at a different operating speed from the first memory device and including first and second caches. The operating method may include: receiving the page data from the first memory device, and determining whether the page data includes one of first data and second data based on the tag information of the page data; storing an index of the first data if it is determined that the page data includes the first data; storing the second data in the first cache if it is determined that the page data includes the second data, and writing back first victim data to the first memory device, the first victim data being selected from among data stored in the first cache when the first cache is full; and storing the first victim data transferred from the first cache in the second cache when a write count of the first victim data is less than a first threshold value, updating tag information of second victim data to a value indicating the first data, the second victim data being selected from among data stored in the second cache when the second cache is full, and storing the second victim data in the first memory device.

### BRIEF DESCRIPTION OF THE DRAWINGS

The above and other features and advantages of the present invention will become more apparent to those skilled in the art to which the present invention belongs by describing in detail various embodiments thereof with reference to the attached drawings in which:

FIG. 1 is a block diagram illustrating a memory system including a hybrid memory device, according to an embodiment of the present invention.

FIG. 2 is a block diagram illustrating a hybrid memory device including a least recently used (LRU) cache.

FIGS. 3A and 3B are diagrams illustrating a configuration of pages, according to the embodiment of the present invention.

FIG. 4 is a block diagram illustrating a hybrid memory device, according to an embodiment of the present invention.

FIGS. 5A and 5B are a block diagram and a flowchart for illustrating an operation of a data determination unit of FIG. 4, respectively.

FIGS. 6A and 6B are a block diagram and a flowchart for illustrating a first operation of a least recently used (LRU) cache of FIG. 4, respectively.

FIGS. 7A and 7B are a block diagram and a flowchart for illustrating a first operation of a cold data candidate cache of FIG. 4, respectively.

FIGS. 8A and 8B are a block diagram and a flowchart for illustrating an operation of a cold data index management unit and a second operation of the least recently used (LRU) cache in FIG. 4, respectively.

FIGS. 9A and 9B are a block diagram and a flowchart for illustrating a second operation of the cold data candidate cache of FIG. 4, respectively.

FIG. 10 is a block diagram illustrating a memory system including the hybrid memory device shown in FIG. 4.

FIG. 11 is a block diagram illustrating an application example of the memory system shown in FIG. 10, according to an embodiment of the present invention.

FIG. 12 is a block diagram illustrating a computing system including the memory system shown in FIG. 11, according to an embodiment of the invention.

### DETAILED DESCRIPTION

Various embodiments will be described below in more detail with reference to the accompanying drawings. The present invention may, however, be embodied in different forms and should not be construed as being limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention. It is also noted that in this specification, “connected/coupled” refers to one element not only directly coupling another element but also indirectly coupling another element through an intermediate component. It will be understood that, although the terms “first”, “second”, “third”, and so on may be used herein to describe various elements, these elements are not limited by these terms. These terms are used to distinguish one element from another element. Thus, a first element could be termed a second element or a third element without departing from the spirit and scope of the present invention. In addition, it will also be understood that when an element is referred to as being “between” two elements, it can be the only element between the two elements, or one or more intervening elements may also be present.

It will be further understood that the terms “comprises”, “comprising”, “includes”, and “including” when used in this specification, specify the presence of the stated elements, but do not preclude the presence or addition of one or more other elements.

The terminology used herein is for the purpose of describing particular embodiments only and is not intended to be limiting of the present invention. Unless otherwise defined, all terms including technical and scientific terms used herein have the same meaning as commonly understood by one of ordinary skill in the art to which this invention belongs in light of the present disclosure. It will be further understood that terms, such as those defined in commonly used dictionaries, should be interpreted as having a meaning that is consistent with their meaning in the context of the present disclosure and the relevant art and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present disclosure.

Hereinafter, the various embodiments of the present invention will be described in detail with reference to the drawings.

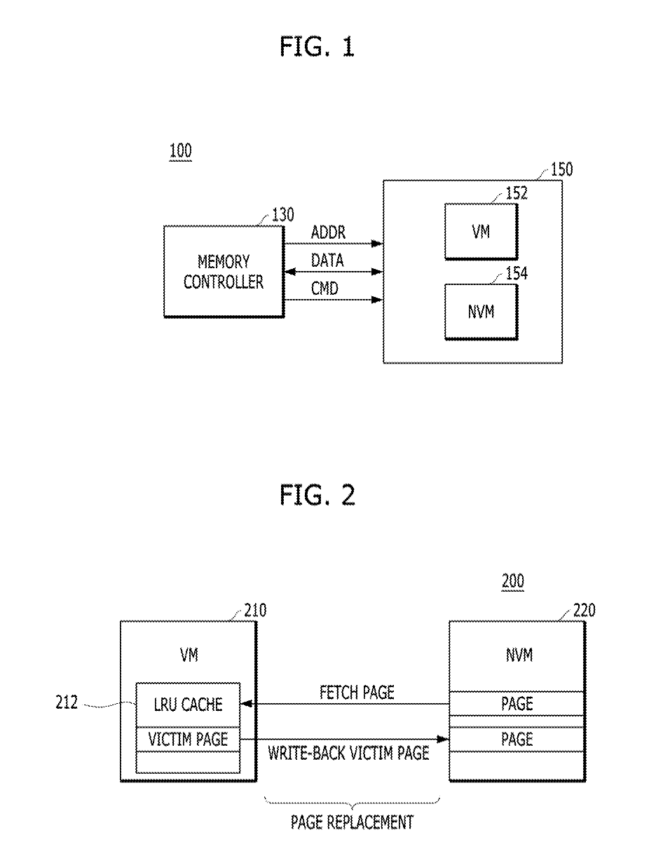

Referring now to FIG. 1 a memory system 100 is provided, according to an embodiment of the present invention.

According to the embodiment of FIG. 1, the memory system 100 includes a hybrid memory device 150 and a memory controller 130. The memory device 150 may store data accessed by a host (not illustrated) coupled to the memory system 100. The memory controller 130 may control data storage to the hybrid memory device 150.

The memory controller 130 may provide a command CMD, an address ADDR and data to the hybrid memory device 150 in response to a request from the host, and control read, write, program and erase operations of the hybrid memory device 150. For example, the memory controller 130 may provide data read from the hybrid memory device 150 to the host, and store data provided from the host in the hybrid memory device 150.

The hybrid memory device 150 may receive a command CMD, an address ADDR and data DATA from the memory controller 130. The command CMD may be, for example, a write command. When a command CMD corresponding to a write command is received, the hybrid memory device 150 may write data DATA to a memory region corresponding to the address ADDR. The command CMD may also be, for example, a read command. When a command CMD corresponding to a read command is received, the hybrid memory device 150 may read data DATA from a memory region corresponding to the address ADDR, and transfer the read data to the memory controller 130.

The hybrid memory device 150 may include a volatile memory device (VM) 152 and a nonvolatile memory device (NVM) 154, as illustrated in FIG. 1. Each of the VM 152 and the NVM 154 may operate as an independent semiconductor chip, and the hybrid memory device 150 may be or include a multi-chip package (MCP). The VM 152 may be or include a Dynamic Random Access Memory (DRAM), and/or a Static RAM (SRAM). The NVM 154 may be or include a Read Only Memory (ROM), a Mask ROM (MROM), a Programmable ROM (PROM), an Erasable Programmable ROM (EPROM), an Electrically Erasable Programmable ROM (EEPROM), a Ferroelectric RAM (FRAM), a Phase Change RAM (PCRAM), a Spin-Torque Transfer RAM (STT-RAM), a Resistive RAM (RRAM), a flash memory and the like. In some embodiments, the VM 152 may be implemented with DRAM, and the NVM 154 may be implemented with PCRAM.

In general, PCRAM has more excellent scalability, but lower write/read speed than a DRAM. Also a PCRAM uses a larger amount of energy during a write operation, and has a limited write durability. Thus, in some embodiments, the hybrid memory device 150 may use the low-speed NVM 154 implemented with a PCRAM as a main memory, and use the high-speed VM 152 implemented with DRAM as a buffer memory.

The memory system may store data in a cache memory before storing the data in the main memory, thereby reducing the number of merge operations or block erase operations. For example, the VM 152 may be a DRAM employed as a cache memory while the NVM 154 may be a PCRAM. Hence, for example, the memory system may store data which are frequently referred to in the high-speed VM device 152 (e.g., DRAM) employed as a cache memory, and may thus reduce the number of accesses to the low-speed NVM 154 (e.g., a PCRAM), thereby improving the performance of the overall memory system. Since the cache memory has a limited space, the cache memory may need to erase existing data when the cache memory is full, in order to load new data. For this operation, the cache memory may erase data which are less likely to be referred to or write back the data to the main memory, and replace the data of the corresponding space with new data, using a cache replacement policy, such as a Least Recently Used (LRU) or First-In First-Out (FIFO) scheme.

The hybrid memory device 150 may use the relatively high-speed VM 152 as a cache memory of the NVM 154, or allocate a part of the VM 152 to a cache memory region of the NVM 154.

Hereafter, a hybrid memory device including a cache which is operated according to an LRU list (hereafter, referred to as ‘LRU’ cache) will be described with reference to the corresponding drawing.

FIG. 2 is a block diagram illustrating a hybrid memory device 200 including a Least Recently Used (LRU) cache 212.

Referring to FIG. 2, the hybrid memory device 200 may use a part of a relatively high-speed volatile memory device (VM) 210 as a cache memory of a nonvolatile memory device (NVM) 220. For example, the VM 210 may include the LRU cache 212 which is operated based on a Least Recently Used (LRU) list, and the NVM 220 may control the LRU cache 212 to manage data which are frequently referred to, thereby improving the operating speed. In an embodiment, the LRU list may be stored in the VM 210.

Under the supposition that data are managed on a page basis, the LRU cache 212 may perform a page replacement operation, when the LRU cache 212 is full. The page replacement operation may include selecting a replacement target page or victim page based on the LRU list, writing back the selected victim page to the main memory, fetching a new page which is required to be used, and storing the fetched page in the cache instead of the victim page.

Hereinafter, data which are written or read at a high frequency may also be referred to as hot data, whereas data which are written or read at a low frequency may be referred to as cold data. The LRU cache 212 of the hybrid memory device 200 cannot distinguish between hot data and cold data while managing the hot data and the cold data. Thus, since the cache space is wasted by the cold data, the page replacement operation may frequently occur. Thus, the entire performance of the memory device may be degraded.

Hereafter, a method for managing hot data and cold data in the hybrid memory device 200 including the LRU cache 212 according to an embodiment of the present invention will be described with reference to the corresponding drawings.

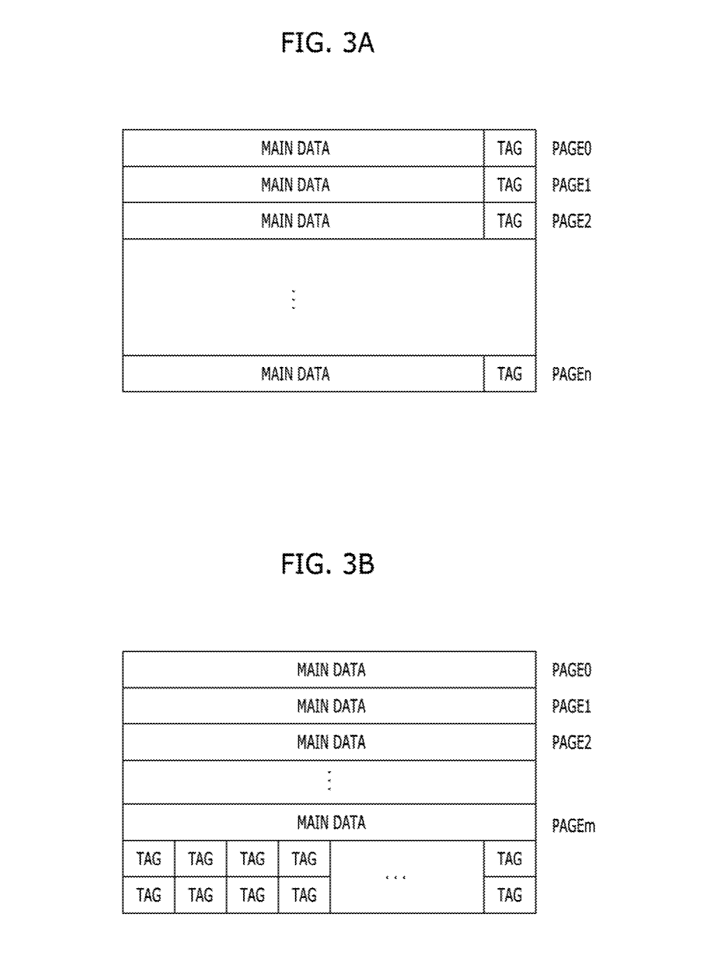

FIGS. 3A and 3B are diagrams illustrating a configuration of pages stored in a nonvolatile memory device (NVM) (e.g., NVM 220 in FIG. 2) according to an embodiment.

Referring to FIG. 3A, a page stored in the NVM 220 may include main data and tag information TAG. The tag information TAG may include information indicating whether the corresponding main data is cold data or not. That is, when the main data corresponds to cold data, the tag information TAG may be marked by ‘1’, while when the main data corresponds to hot data or data which cannot yet be defined, that is, normal data excluding cold data, the tag information TAG may be marked by ‘0’.

For reference, as illustrated in FIG. 3A, tag information TAG may be stored in a partial bit of each main data, and thus included in the corresponding page. Alternatively, as illustrated in FIG. 3B, a part of the NVM 220 may be allocated to a tag information region, such that plural pieces of tag information TAG are gathered and managed in the tag information region.

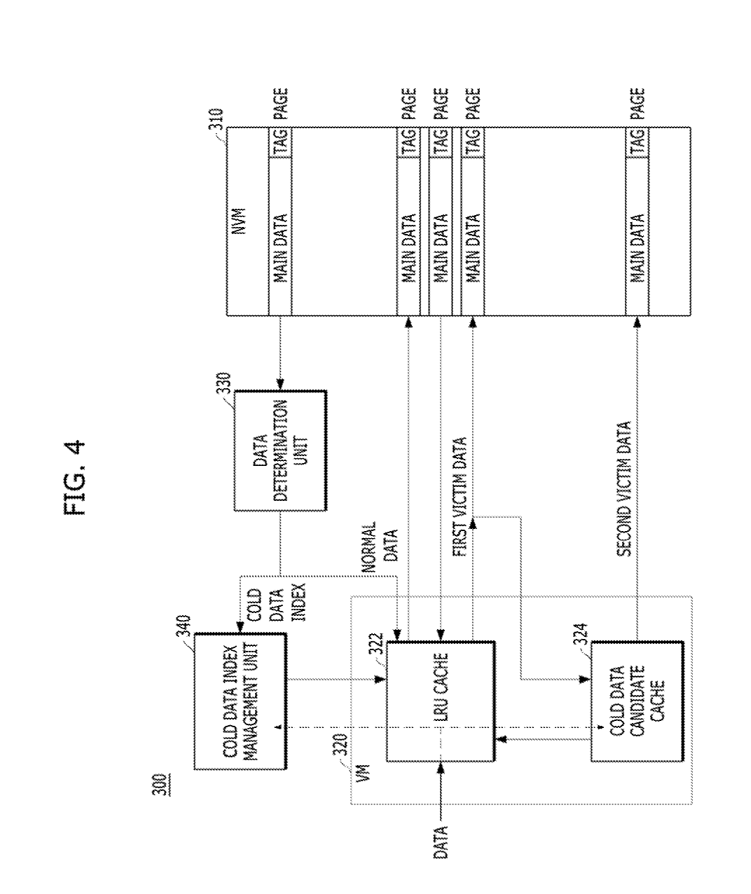

FIG. 4 is a block diagram illustrating a hybrid memory device 300 according to an embodiment of the present invention.

Referring to FIG. 4, the hybrid memory device 300 according to the present embodiment may include a nonvolatile memory (NVM) 310 used as a main memory device and a volatile memory (VM) 320 used as a buffer memory device. In the present embodiment, a part of the VM 320 may be used as a cache of the NVM 310. In some embodiments, the VM 320 may be implemented with DRAM, and the NVM 310 may be implemented with PCRAM. In the present embodiment, the case in which a part of the VM 320 is used as a cache of the NVM 310 is taken as an example for description, but the present embodiment is not limited thereto. For example, the NVM 310 may be used as a buffer memory or main memory.

Hereafter, suppose that a page stored in the NVM 310 includes the main data and the tag information TAG which are illustrated in FIG. 3A.

The hybrid memory device 300 may include a data determination unit 330 and a cold data index management unit 340. In some embodiments, the data determination unit 330 and the cold data index management unit 340 are implemented with a control logic. The data determination unit 330 may receive normal data from the NVM 310 in same size blocks, such as, for example, page data as illustrated in FIG. 4. The data determination unit 330 may then classify the received data into first and second data based on the tag information TAG of the page data. The cold data index management unit 340 may store and manage indexes of the first data. For reference, the tag information TAG may be marked by ‘1’ when the corresponding data is cold data, and marked by ‘0’ when the corresponding data is normal data excluding cold data. For convenience of description, the first data may be defined as cold data, and the second data may be defined as normal data. That is, the data determination unit 330 may distinguish between cold data and normal data based on the tag information TAG of the page data received from the NVM 310. The cold data index management unit 340 may store and manage the index of the cold data. In an embodiment, an index may include a physical address or logic address.

More specifically, the VM 320 may include a least recently used (LRU) cache 322 and a cold data candidate cache 324. The LRU cache 322 may store normal data. The LRU cache 322 may write back first victim data to the NVM 310, the first victim data being selected when the LRU cache 322 is full. The cold data candidate cache 324 may store the first victim data received from the LRU cache 322, when the write count of the first victim data is smaller than a first threshold value TH1. The cold data candidate cache 324 may mark tag information TAG of second victim data such that the tag information TAG represents cold data, the second victim data being selected when the cold data candidate cache 324 is full. In other words, the cold data candidate cache 324 may update the tag information TAG of the second victim data to ‘1’, and then store the second victim data in the NVM 310. In an embodiment, when the LRU cache 322 and the cold data candidate cache 324 are full, the LRU cache 322 and the cold data candidate cache 324 may select first and second victim data according to the LRU list. According to a scheme using the LRU list, least recently used data among normal data may be selected victim data. For example, the least recently used data is selected as the first victim data, from among data stored in the LRU cache 322, and the least recently used data is selected as the second victim data, from among data stored in the cold data candidate cache 324. However, the present embodiment is not limited thereto, and the LRU cache 322 and the cold data candidate cache 324 may select victim data according to a Least Frequently Used (LFU) list or First-In First-Out (FIFO) list.

The cold data index management unit 340 may store the write counts of the cold data as well as the indexes of the cold data. That is, when a write access corresponding to cold data indicated by a stored index is detected from an external controller (not illustrated), the cold data index management unit 340 may increase the write count corresponding to the cold data. Furthermore, the LRU cache 322 may store the write counts of normal data as well as the normal data. That is, when a write access corresponding to normal data is detected from the external controller, the LRU cache 322 may increase the write count corresponding to the normal data.

The VM 320 may have much higher write speed and slightly higher read speed than the NVM 310. Based on such a characteristic, the hybrid memory device 300 according to the present embodiment may not manage hot data and cold data using access counts each including a read count and a write count, but manage hot data and cold data using write counts. Thus, the hybrid memory device 300 can classify and manage hot data and cold data using a cache with a relatively small capacity.

As described above, the hybrid memory device according to the present embodiment can separately manage a page having tag information corresponding to cold data using a write count, thereby reducing the ratio of a cache space occupied by the cold data. Thus, the hybrid memory device can reduce unnecessary page replacement operations which are performed by the cache when the cache is full, thereby improving the bandwidth of the memory device.

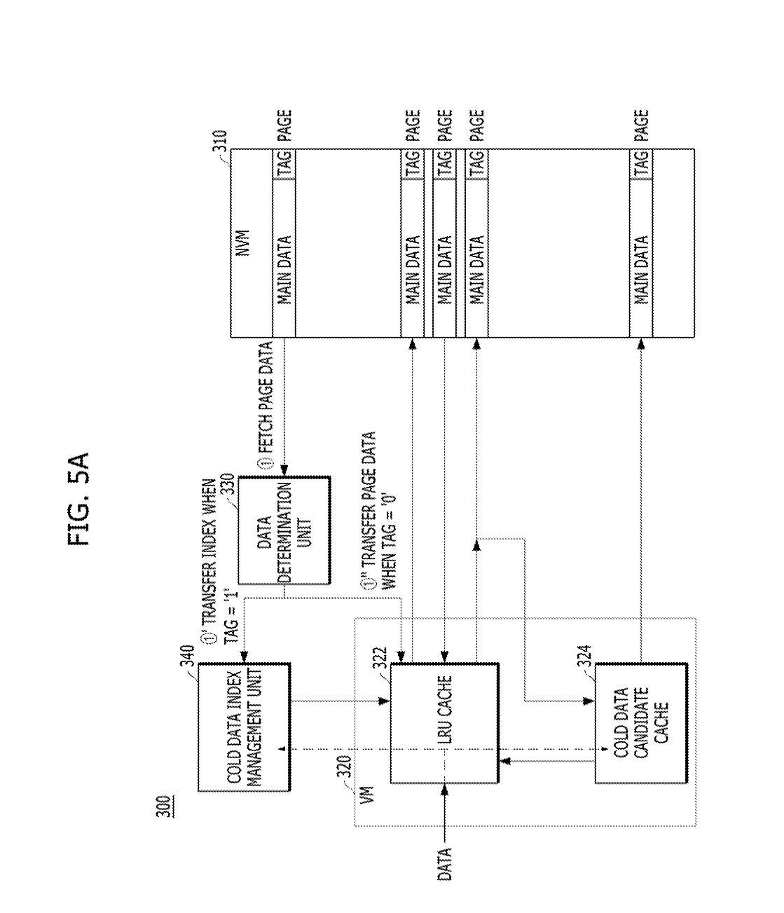

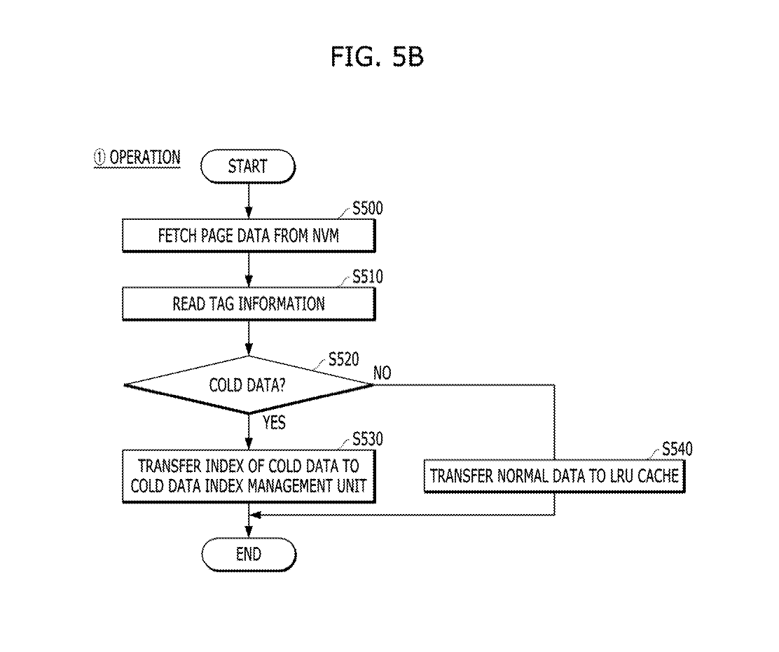

Hereafter, referring to FIGS. 5A to 9B, the operations of the respective units of the hybrid memory device according to the present embodiment will be described in more detail.

FIGS. 5A and 5B are a block diagram and a flowchart for illustrating an operation of the data determination unit 330 of FIG. 4, respectively.

Referring to FIGS. 5A and 5B, the data determination unit 330 may fetch page data from the NVM 310 at step S500 (\textcircled{1}). The data determination unit 330 may read the tag information TAG of the fetched page data at step S510, and determine whether the page data are cold data, based on the read tag information TAG, at step S520. At this time, when the tag information TAG is ‘1’, the data determination unit 330 may determine that the page data are cold data. When the tag information is ‘0’, the data determination unit 330 may determine that the page data are normal data excluding the cold data.

When the page data are cold data (YES at step S520), the data determination unit 330 may transfer the index of the cold data to the cold data index management unit 340 at step S530 (\textcircled{1}′). When the page data are not cold data (NO at step S520), the data determination unit 330 may transfer normal data excluding the cold data to the LRU cache 322 at step S540 (\textcircled{1}″).

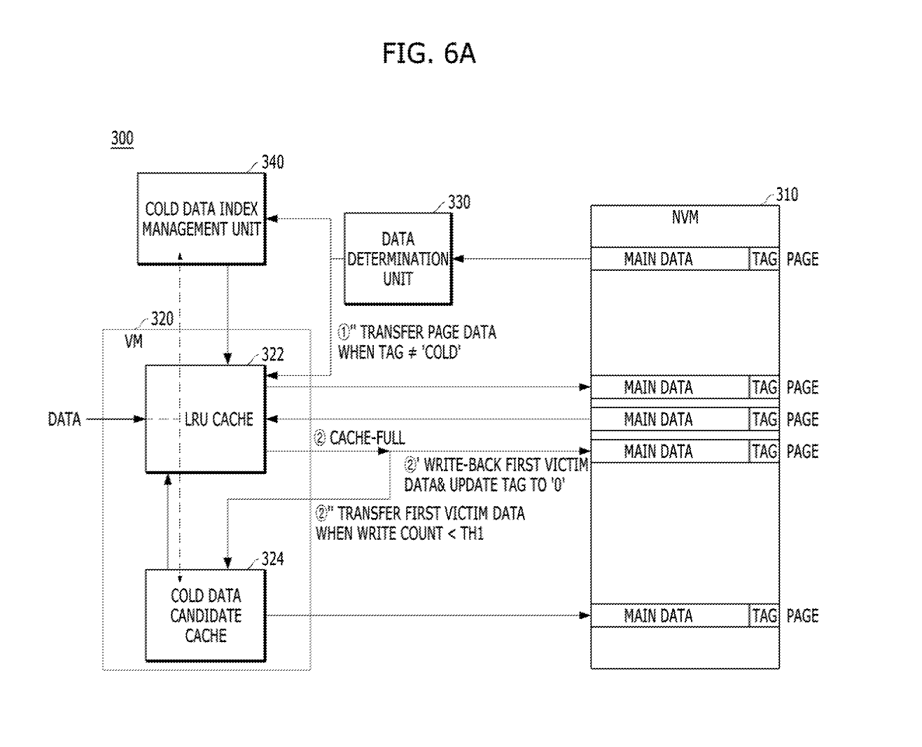

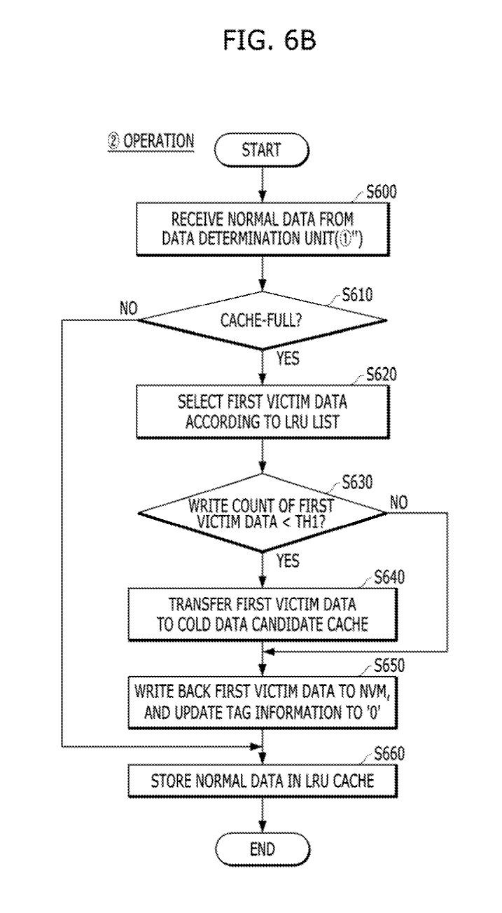

FIGS. 6A and 68B are a block diagram and a flowchart for illustrating a first operation of the LRU cache 322 of FIG. 4, respectively.

Referring to FIGS. 6A and 6B, when the normal data are transferred from the data determination unit 330 at step S600 (\textcircled{1}″), the LRU cache 322 may check whether the cache is full, at step S610 (\textcircled{2}). When the cache is not full (NO at step S610), the LRU cache 322 may store the transferred normal data therein at step S660, and then end the operation.

When the cache is full (YES at step S610), the LRU cache 322 may select first victim data (i.e., least recently used data) from among data stored in the cache according to the LRU list, at step S620. At this time, the LRU cache 322 may determine whether the write count of the selected first victim data is less than a first threshold value TH1, at step S630. When the write count of the first victim data is less than the first threshold value TH1 (YES at step S630), the LRU cache 322 may transfer the first victim data to the cold data candidate cache 324 at step S640 (\textcircled{2}″). When the write count of the first victim data is not less than (i.e., equal to or greater than) the first threshold value TH1 (NO at step S630), the LRU cache 322 may proceed to step S650.

Then, the LRU cache 322 may write back the first victim data to the NVM 310 at step S650 (\textcircled{2}′). At this time, the LRU cache 322 may update the tag information TAG of the first victim data to ‘0’ indicating normal data. After the first victim data are written back to the NVM 310, the LRU cache 322 may perform a page replacement operation by storing normal data in the corresponding space of the LRU cache 322 at step S660.

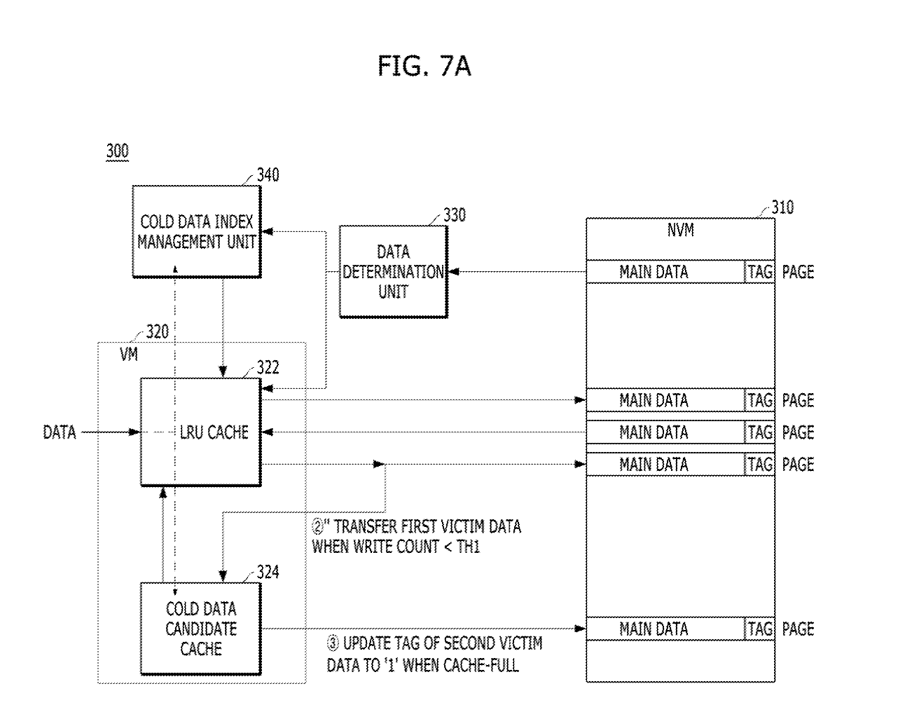

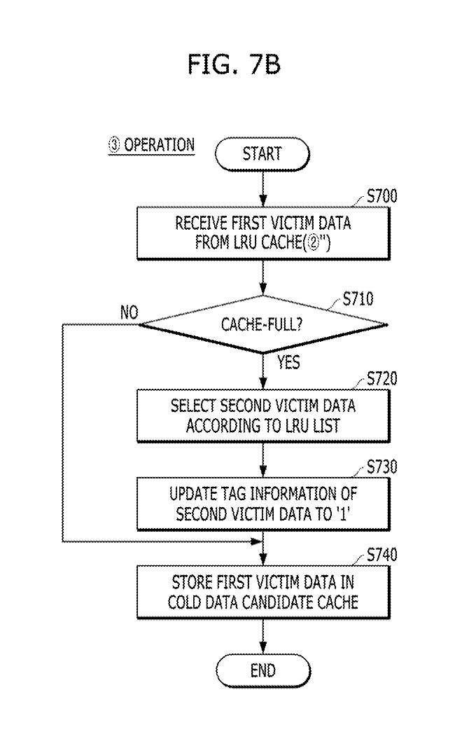

FIGS. 7A and 7B are a block diagram and a flowchart for illustrating a first operation of the cold data candidate cache 324 of FIG. 4, respectively.

Referring to FIGS. 7A and 7B, when the first victim data is transferred from the LRU cache 322 at step S700 (\textcircled{2}″), the cold data candidate cache 324 may check whether the cache is full, at step S710. When the cache is not full (NO at step S710), the cold data candidate cache 324 may store the transferred first victim data therein at step S740, and then end the operation.

When the cache is full (YES at step S710), the cold data candidate cache 324 may select second victim data (i.e., least recently used data) from among data stored in the cache according to the LRU list, at step S720. The cold data candidate cache 324 may update the tag information TAG of the second victim data to ‘1’ indicating cold data, at step S730 (\textcircled{3}), and then store the second victim data in the NVM 310.

Then, the cold data candidate cache 324 may perform a page replacement operation by erasing the second victim data and storing the first victim data in the corresponding space at step S740.

In the present embodiment, the case in which the second victim data are erased has been taken as an example. However, the cold data candidate cache 324 may perform a page replacement operation by writing back the second victim data to the NVM 310 and then storing the first victim data in the corresponding space of the cold data candidate cache 324 at step S740.

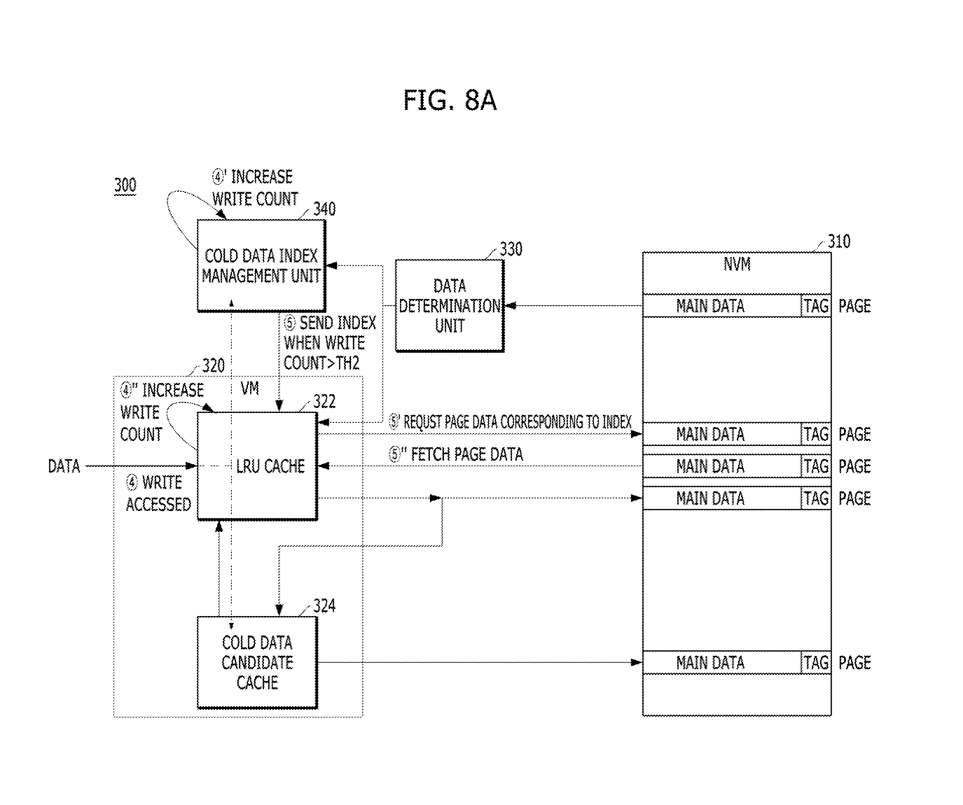

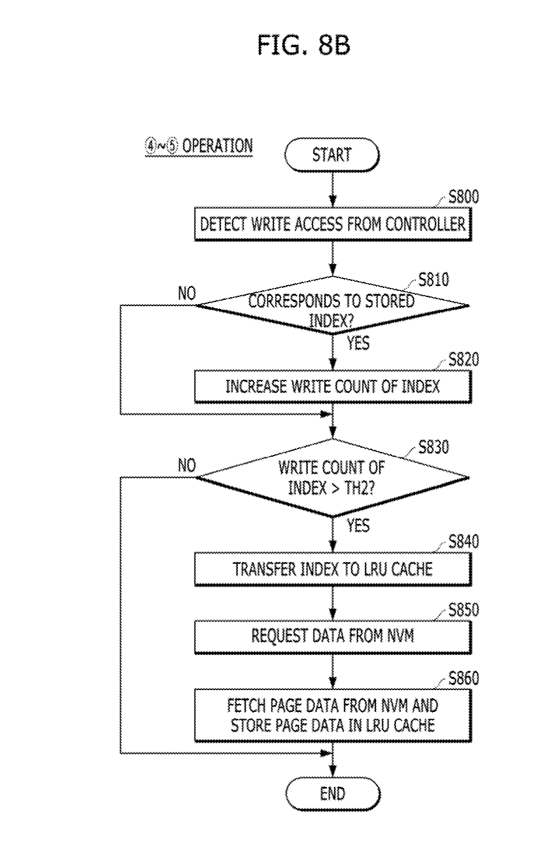

FIGS. 8A and 8B are a block diagram and a flowchart for illustrating an operation of the cold data index management unit 340 and a second operation of the LRU cache 322 in FIG. 4, respectively.

Referring to FIGS. 8A and 8B, when a write access is detected from an external controller (not illustrated) at step S800 (\textcircled{4}), the cold data index management unit 340 may determine whether the write access corresponds to cold data indicated by an index stored therein, at step S810. When the detected write access corresponds to the cold data indicated by the stored index (YES at step S810), the cold data index management unit 340 may increase the write count corresponding to the cold data at step S820 (\textcircled{4}′). Furthermore, when a write access corresponding to normal data is detected from the external controller, the LRU cache 322 may increase the write count corresponding to the normal data at step S820 (\textcircled{4}″).

The cold data index management unit 340 may determine whether the write count of the cold data indicated by the stored index is greater than a second threshold value TH2, at step S830. When the write count of the cold data is not greater than (i.e., equal to or less than) the second threshold value TH2 (NO at step S830), the cold data index management unit 340 may end the operation.

When the write count of the cold data is greater than the second threshold value TH2 (YES at step S830), the cold data index management unit 340 may send the corresponding index to the LRU cache 322 at step S840 (\textcircled{5}). When the index is received, the LRU cache 322 may request page data indicated by the received index from the NVM 310 at step S850 (\textcircled{5}′), fetch the corresponding page data from the NVM 310, and store the fetched page data in the LRU cache 322 at step S860 (\textcircled{5}″).

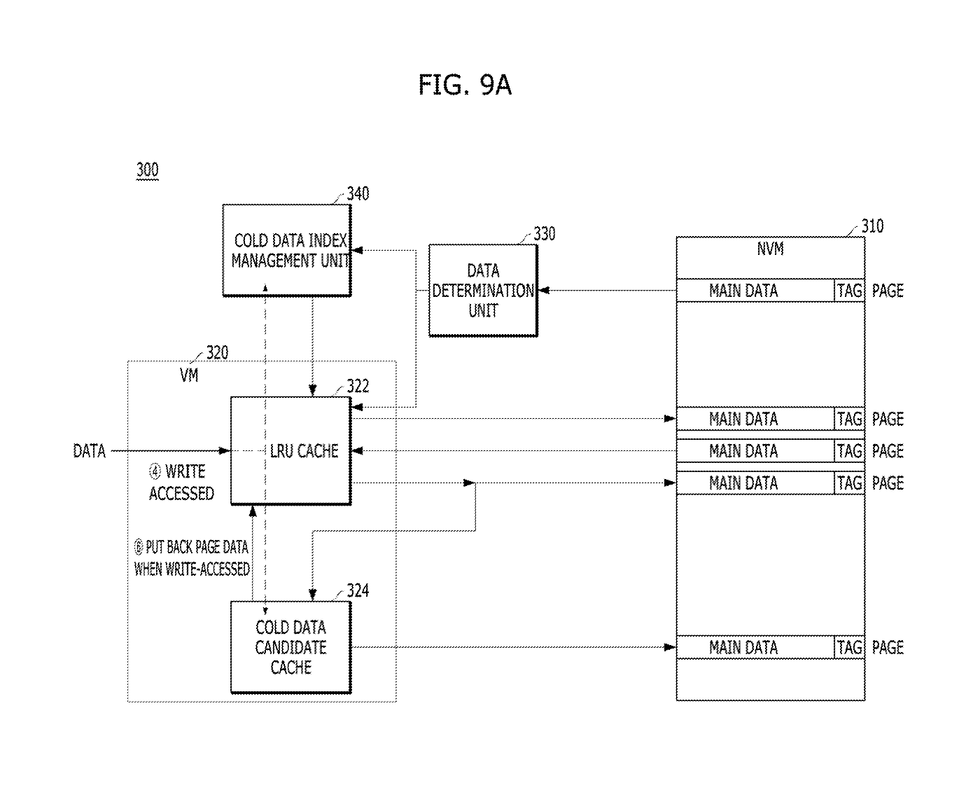

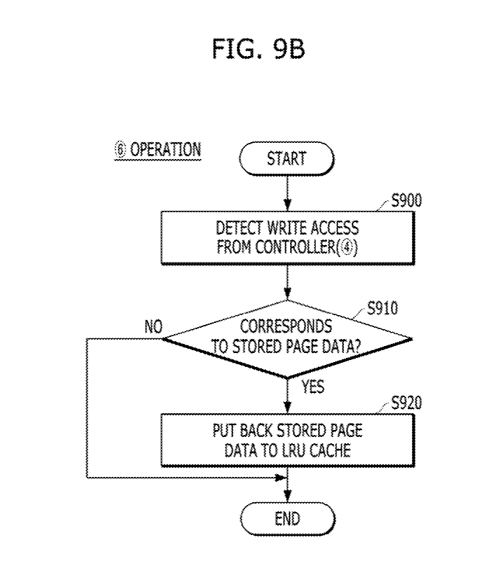

FIGS. 9A and 9B are a block diagram and a flowchart for illustrating a second operation of the cold data candidate cache 324 of FIG. 4, respectively.

Referring to FIGS. 9A and 9B, when a write access is detected from the external controller (not illustrated) at step S900 (\textcircled{4}), the cold data candidate cache 324 may determine whether the detected write access corresponds to page data stored therein, at step S910. When the detected write access corresponds to the stored page data (YES at step S910), the cold data candidate cache 324 may put back the page data to the LRU cache 322 at step S920. When the detected write access does not correspond to page data stored therein (NO at step S910), the cold data candidate cache 324 may end the operation.

Referring to the drawings, a data management method of the hybrid memory device according to an embodiment will be described briefly as follows.

The data determination unit 330 may fetch page data from the NVM 310. When the tag information TAG of the fetched page data is ‘0’ (i.e., the fetched page data is normal data), the data determination unit 330 may transfer the page data to the LRU cache 322.

The LRU cache 322 may store the page data, and provide the page data whenever an access request corresponding to the stored page data is provided from the external controller (not illustrated). The LRU cache 322 may write back first victim data to the NVM 310, the first victim data being selected from among data stored in the LRU cache 322 according to the LRU list, when the cache is full. At this time, when the write count of the first victim data is less than the first threshold value TH1, the LRU cache 322 may store the first victim data in the cold data candidate cache 324, in order to manage potential cold data candidates.

When the cold data candidate cache 324 is full, the cold data candidate cache 324 may update the tag information TAG of second victim data to ‘1’, the second victim data being selected from among data stored in the cold data candidate cache 324 according to the LRU list, and store the second victim data in the NVM 310.

Then, the data determination unit 330 may fetch page data from the NVM 310. When the tag information TAG of the fetched page data is ‘1’ (i.e., the fetched page data is cold data), the cold data index management unit 340 may store the index of the corresponding page data, to separately manage cold data.

As described above, the hybrid memory device according to the present embodiment can increase the probability that pages including hot data rather than pages including cold data will occupy the LRU cache. Thus, since unnecessary page replacement operations can be reduced, the reduction of the bandwidth can be prevented.

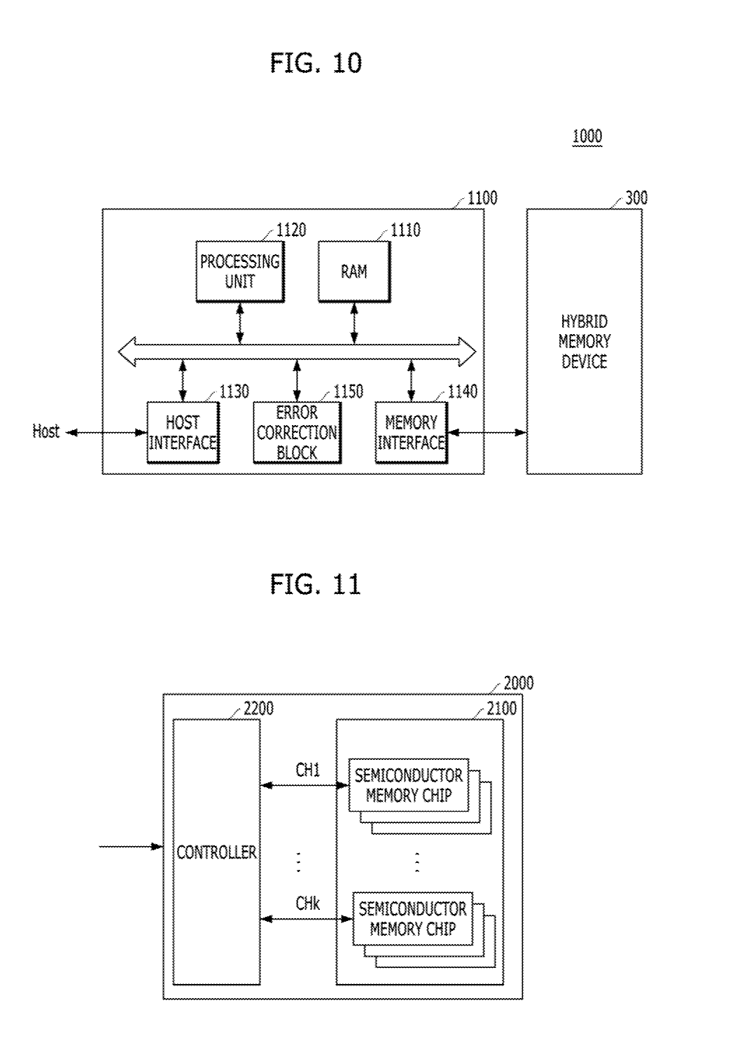

FIG. 10 is a block diagram illustrating a memory system 1000 including the hybrid memory device 300 shown in FIG. 4, according to an embodiment of the present invention.

According to the embodiment illustrated in FIG. 10, the memory system 1000 may include the hybrid memory device 300 and a controller 1100.

Since the hybrid memory device 300 is configured and manufactured as described above with reference to FIG. 4, a detailed description thereof will be omitted.

The controller 1100 may be connected to a host and the hybrid memory device 300 and may be suitable for accessing the hybrid memory device 300 in response to a request from the host. For example, the controller 1100 may be suitable for controlling read, write, erase and background operations of the hybrid memory device 300. The controller 1100 may be suitable for performing interfacing between the hybrid memory device 300 and the host. The controller 1100 may be suitable for operating firmware to control the hybrid memory device 300.

The controller 1100 may include a random access memory (RAM) 1110, a processing unit (e.g., a central processing unit (CPU)) 1120, a host interface 1130, a memory interface 1140, and an error correction block 1150 operatively linked through an internal bus. The RAM 1110 may be used as an operation memory of the CPU 1120, a cache memory between the memory device 1200 and the host, and a buffer memory between the memory device 1200 and the host. The processing unit 1120 may control the overall operation of the controller 1100. The controller 1100 may temporarily store program data provided from the host during a read operation.

The host interface 1130 may include a protocol for data exchange between the host and the controller 1100. For example, the controller 1100 may communicate with the host through at least one of various protocols, such as a Universal Serial Bus (USB) protocol, a Multimedia Card (MMC) protocol, a Peripheral Component Interconnection (PCI) protocol, a PCI-Express (PCI-E) protocol, an Advanced Technology Attachment (ATA) protocol, a Serial-ATA protocol, a Parallel-ATA protocol, a Small Computer Small Interface (SCSI) protocol, an Enhanced Small Disk Interface (ESDI) protocol, an Integrated Drive Electronics (IDE) protocol and a private protocol.

The memory interface 1140 may be suitable for performing interfacing with the hybrid memory device 300. For example, the memory interface 1140 may include a NAND flash interface or a NOR flash interface.

The error correction block 1150 may be suitable for detecting and correcting errors in data read from the hybrid memory device 300 using an error correcting code. The processing unit 1120 may control a read voltage according to an error detection result of the error correction block 1150 and control the hybrid memory device 300 to perform a re-read operation. According to an embodiment, the error correction block 1150 may be provided as a component of the controller 1100.

The controller 1100 and the hybrid memory device 300 may be integrated in one semiconductor device. According to an embodiment, the controller 1100 and the hybrid memory device 300 may be integrated in a single semiconductor device to form a memory card, such as a personal computer memory card international association (PCMCIA), a compact flash card (CF), a smart media card (SMC), a memory stick, a multimedia card (MMC), a reduced size MMC (RS-MMC), a micro-MMC, a secure digital (SD) card, a mini-SD, a micro-SD, an SDHC, a universal flash storage device (UFS), and the like.

The controller 1100 and the hybrid memory device 300 may be integrated in one semiconductor device to form a semiconductor drive, e.g., a Solid State Drive (SSD). The semiconductor drive (e.g., SSD) may include a storage device configured to store data in a semiconductor memory. When the memory system 1000 is used as the semiconductor drive (e.g., SSD), the operating speed of the host coupled to the memory system 1000 may be significantly improved.

In another example, the memory system 1000 may be used as one of various components of an electronic device, such as a computer, an ultra mobile PC (UMPC), a workstation, a net-book, personal digital assistants (PDAs), a portable computer, a web tablet, a wireless phone, a mobile phone, a smart phone, an e-book, a portable multimedia player (PMP), a portable game machine, a navigation device, a black box, a digital camera, a three-dimensional (3D) television, a digital audio recorder, a digital audio player, a digital picture recorder, a digital picture player, a digital video recorder, a digital video player, a device for transmitting/receiving information in wireless environment, one of various electronic devices for home networks, one of various electronic devices for computer networks, one of various electronic devices for telematics networks, an RFID device and/or one of various devices for computing systems, and the like.

In an exemplary embodiment, the hybrid memory device 300 or the memory system 1000 may be packaged in a variety of ways. For example, in some embodiments, the hybrid memory device 300 or the memory system 1000 may be packaged using various methods, such as a package on package (POP), ball grid arrays (BGAs), chip scale packages (CSPs), a plastic leaded chip carrier (PLCC), a plastic dual in line package (PDIP), a die in waffle pack, a die in wafer form, a chip on board (COB), a ceramic dual in line package (CERDIP), a plastic metric quad flat pack (MQFP), a thin quad flatpack (TQFP), a small outline (SOIC), a shrink small outline package (SSOP), a thin small outline (TSOP), a thin quad flatpack (TQFP), a system in package (SIP), a multi-chip package (MCP), a wafer-level fabricated package (WFP) and/or a wafer-level processed stack package (WSP), and the like.

FIG. 11 is a block diagram illustrating an application example 2000 of the memory system 1000 shown in FIG. 10.

According to the embodiment illustrated in FIG. 11, the memory system 2000 may include a semiconductor memory device 2100 and a controller 2200. The semiconductor memory device 2100 may include a plurality of semiconductor memory chips. The semiconductor memory chips may be divided into a plurality of groups.

In FIG. 11, the plurality of groups in the semiconductor memory chips communicate with the controller 2200 through first to k-th channels CH1 to CHk, respectively. Each of the memory chips may be configured and operated in substantially the same manner as the hybrid memory device 300 described above with reference to FIG. 4.

Each of the groups in the semiconductor memory chips may communicate with the controller 2200 through a single common channel. The controller 2200 may be configured in substantially the same manner as the controller 1100 described above with reference to FIG. 10 and may control the plurality of memory chips of the semiconductor memory device 2100.

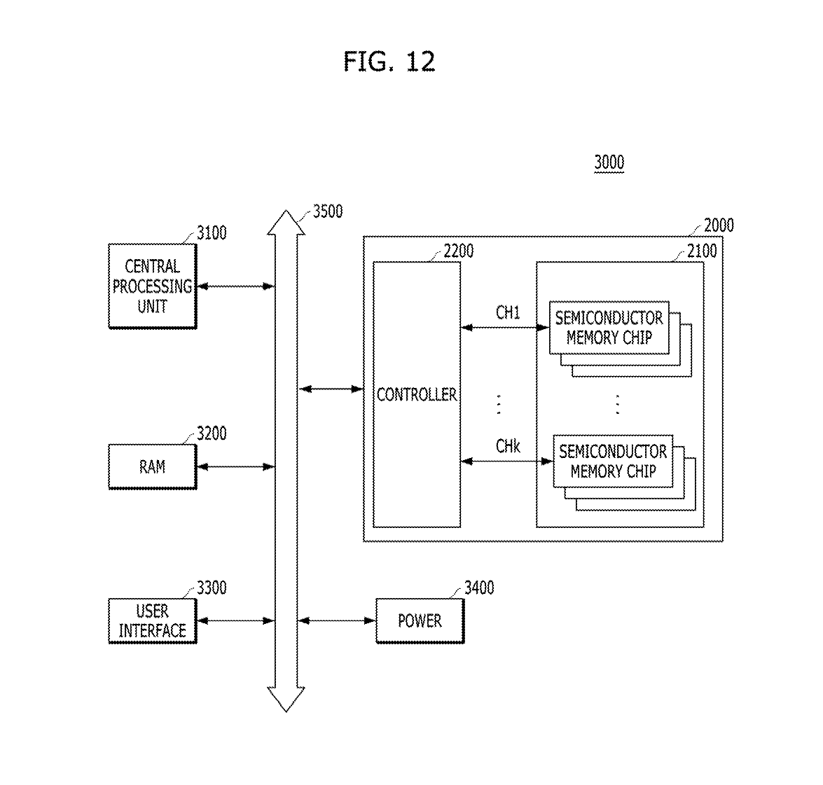

FIG. 12 is a block diagram illustrating a computing system including the memory system 2000 shown in FIG. 11, according to an embodiment of the invention.

According to the embodiment illustrated in FIG. 12, the computing system 3000 may include a central processing unit 3100, random access memory (RAM) 3200, a user interface 3300, a power supply 3400, a system bus 3500, and the memory system 2000.

The memory system 2000 may be electrically connected to the central processing unit 3100, the RAM 3200, the user interface 3300 and the power supply 3400 through the system bus 3500. Data provided through the user interface 3300 or processed by the central processing unit 3100 may be stored in the memory system 2000 including the semiconductor memory device 2100 and the controller 2200.

In FIG. 12, the semiconductor memory device 2100 may be coupled to the system bus 3500 through the controller 2200. However, the semiconductor memory device 2100 may be directly coupled to the system bus 3500. Functions of the controller 2200 may be performed by the central processing unit 3100 and the RAM 3200.

FIG. 12 illustrates the memory system 2000 described above with reference to FIG. 11. However, the memory system 2000 may be replaced with the memory system 1000 described above with reference to FIG. 10. In an exemplary embodiment, the computing system 3000 may include both memory systems 1000 and 2000 described above with reference to FIGS. 10 and 11, respectively.

Although various embodiments have been described for illustrative purposes, it will be apparent to those skilled in the relevant art that various changes and modifications may be made without departing from the spirit and/or scope of the invention as defined in the following claims.

For example, the positions and types of the logic gates and transistors illustrated in the aforementioned embodiments may have been differently implemented depending on the polarity of an input signal.

Moreover, in some instances, as would be apparent to those skilled in the relevant art elements described in connection with a particular embodiment may be used singly or in combination with other embodiments unless otherwise specifically indicated.

What is claimed is:

1. A memory device comprising:
a data determination unit suitable for receiving page data from a main memory device, and determining whether the page data includes one of first data and second data based on a tag information of the page data;
an index management unit suitable for storing an index of the first data if it is determined that the page data includes the first data;
a first cache suitable for storing the second data if it is determined that the page data includes the second data, and writing back first victim data to the main memory device, the first victim data being selected when the first cache is full; and
a second cache suitable for storing the first victim data transferred from the first cache when a write count of the first victim data is less than a first threshold value, updating tag information of second victim data to a value indicating the first data, the second victim data being selected when the second cache is full, and storing the second victim data in the main memory device.

2. The memory device of claim 1, wherein the tag information of the page data comprises cold data information, the first data includes cold data, and the second data includes normal data excluding the cold data.

3. The memory device of claim 1, wherein when a write count of the first data is greater than a second threshold value, the index management unit transfers the index of the first data to the first cache.

4. The memory device of claim 3, wherein the first cache fetches page data from the main memory device, the page data corresponding to the index transferred from the index management unit, and stores the fetched page data.

5. The memory device of claim 3, wherein the index management unit stores the index of the first data and the write count of the first data, and increases the write count of the stored index when a write access corresponding to the first data indicated by the stored index is detected.

6. The memory device of claim 1, wherein the first cache stores the second data and a write count of the second data, and increases the write count of the second data when a write access corresponding to the stored second data is detected.

7. The memory device of claim 1, wherein when a write access corresponding to the stored first victim data is detected, the second cache puts back the first victim data to the first cache.

8. The memory device of claim 1, wherein when the first victim data is written back to the main memory device, the first cache updates tag information of the first victim data to a value indicating the second data, and stores the first victim data in the main memory device.

9. The memory device of claim 1, wherein the first and second caches select, as the first and second victim data, least recently used victim data from among victim data stored therein according to a Least Recently Used (LRU) scheme, respectively, when the caches are full.

10. The memory device of claim 1, wherein the main memory device includes a nonvolatile memory device, and the first and second caches include a volatile memory device.

11. A hybrid memory device comprising:
a first memory device suitable for storing page data including page information and tag information;
a control logic suitable for receiving the page data from the first memory device, determining whether the page data includes one of cold data and normal data based on the tag information of the page data, and storing and managing an index of the cold data; and
a second memory device accessed at a different operating speed from the first memory device, and suitable for storing the normal data and updating the tag information of the page data stored in the first memory device according to a write count of the stored normal data.

12. The hybrid memory device of claim 11, wherein the control logic comprises:
a data determination unit suitable for receiving the page data from the first memory device, and determining whether the page data includes one of the cold data and the normal data based on the tag information of the page data; and
an index management unit suitable for storing and managing the index of the cold data.

13. The hybrid memory device of claim 12, wherein the second memory device comprises:
a first cache suitable for storing the normal data, and writing back first victim data to the first memory device, the first victim data being selected from among data stored therein when the first cache is full; and
a second cache suitable for storing the first victim data transferred from the first cache when a write count of the first victim data is less than a first threshold value, updating tag information of second victim data to a value indicating cold data, the second victim data being selected from among data stored therein when the second cache is full, and storing the second victim data in the first memory device.

14. The hybrid memory device of claim 13, wherein when a write count of the cold data is greater than a second threshold value, the index management unit transfers the index of the cold data to the first cache, and
the first cache fetches page data from the first memory device, the page data corresponding to the index transferred from the index management unit, and stores the fetched page data.

15. The hybrid memory device of claim 13, wherein when a write access corresponding to the stored first victim data is detected, the second cache puts back the first victim data to the first cache.

16. The hybrid memory device of claim 13, wherein when the first victim data is written back to the first memory device, the first cache updates the tag information of the first victim data to a value indicating the normal data, and stores the first victim data in the first memory device.

17. An operating method of a hybrid memory device which includes a first memory device suitable for storing page data including page information and tag information and a second memory device accessed at a different operating speed from the first memory device and including first and second caches, the operating method comprising:
receiving the page data from the first memory device, and determining whether the page data includes one of first data and second data based on the tag information of the page data;
storing an index of the first data if it is determined that the page data includes the first data;
storing the second data in the first cache if it is determined that the page data includes the second data, and writing back first victim data to the first memory device, the first victim data being selected from among data stored in the first cache when the first cache is full; and
storing the first victim data transferred from the first cache in the second cache when a write count of the first victim data is less than a first threshold value, updating tag information of second victim data to a value indicating the first data, the second victim data being selected from among data stored in the second cache when the second cache is full, and storing the second victim data in the first memory device.

18. The operating method of claim 17, wherein the tag information of the page data comprises cold data information, the first data includes cold data, and the second data includes normal data excluding the cold data.

19. The operating method of claim 17, further comprising:
transferring an index of the first data to the first cache, when a write count of the first data is greater than a second threshold value; and
fetching page data corresponding to the transferred index from the first memory device, and storing the fetched page data in the first cache.

20. The operating method of claim 17, further comprising putting back the stored first victim data from the second cache to the first cache, when a write access corresponding to the first victim data is detected.

21. The operating method of claim 17, further comprising updating the tag information of the first victim data to a value indicating the second data and storing the first victim data in the first memory device, when the first victim data is written back to the first memory device.
